(19) United States
(12) Patent Application Publication
(10) Pub. No.: US 2018/0246543 A1
(43) Pub. Date: Aug. 30, 2018

(54) SYSTEMS AND METHODS FOR BRACKET

(71) Applicant: NEW YORK UNIVERSITY, New York, NY (US)

(72) Inventor: Joseph James Shelmet, SR., Rahway, NJ (US)

(21) Appl. No.: 15/902,937

(22) Filed: Feb. 22, 2018

Related U.S. Application Data
(60) Provisional application No. 62/464,098, filed on Feb. 27, 2017.

(51) Int. Cl. G06F 1/16

(52) U.S. Cl. CPC G06F 1/1607; F16M 13/02

(57) ABSTRACT

A bracket engageable with a computer monitor for supporting a card reader. The bracket includes an upright portion and a support portion, with a transition portion there between. The support portion extends at an angle of 70 to 120 degrees from the upright portion and is configured to receive the card reader.

### CROSS-REFERENCE TO RELATED PATENT APPLICATION

This application claims priority benefit of U.S. Provisional Application No. 62/464,098 filed Feb. 27, 2017, which is incorporated herein by reference in its entirety.

### TECHNICAL FIELD

The present disclosure relates generally to methods and systems for supporting an object.

### BACKGROUND

Card readers have become ubiquitous in work environments. As security and privacy have become of elevated importance, the solution has often been to rely upon a personal identification system to allow for access to information. Because of the ease of individualization and physical control, physical cards encoded with information have been relied upon. These identification cards can utilize a wide range of technologies for encoding information, including contact ID cards, such as magnetic strip cards and contact chip cards. One common type of technology is non-contact or “proximity” communications, providing for proximity ID cards, for example, near-field communication and RFID.

However, several problems arise with the ID card systems for access control, such as ease of access and visibility of the card reader. In particular, some usage scenarios present an environment that is further difficult for a user to access or be reminded of the card reader, such as mobile, vertical hospital work stations. Thus, there is a need for an improved method and system for presenting a card reader to a user.

### SUMMARY

Embodiments described herein relate generally to a bracket for attachment to a monitor and for supporting a card reader.

It should be appreciated that all combinations of the foregoing concepts and additional concepts discussed in greater detail below (provided such concepts are not mutually inconsistent) are contemplated as being part of the subject matter disclosed herein. In particular, all combinations of claimed subject matter appearing at the end of this disclosure are contemplated as being part of the subject matter disclosed herein.

### BRIEF DESCRIPTION OF DRAWINGS

The foregoing and other features of the present disclosure will become more fully apparent from the following description and appended claims, taken in conjunction with the accompanying drawings. Understanding that these drawings depict only several implementations in accordance with the disclosure and are therefore, not to be considered limiting of its scope, the disclosure will be described with additional specificity and detail through use of the accompanying drawings.

FIG. 1 illustrates a perspective view of a bracket.

FIG. 2 illustrates a side view of a bracket.

FIG. 3 illustrates a rear view of a bracket affixed to a computer monitor.

FIG. 4 illustrates a front view of a card reader mounted to a computer monitor by a bracket.

Reference is made to the accompanying drawings throughout the following detailed description. In the drawings, similar symbols typically identify similar components, unless context dictates otherwise. The illustrative implementations described in the detailed description, drawings, and claims are not meant to be limiting. Other implementations may be utilized, and other changes may be made, without departing from the spirit or scope of the subject matter presented here. It will be readily understood that the aspects of the present disclosure, as generally described herein, and illustrated in the figures, can be arranged, substituted, combined, and designed in a wide variety of different configurations, all of which are explicitly contemplated and made part of this disclosure.

### DETAILED DESCRIPTION OF VARIOUS EMBODIMENTS

Embodiments described herein relate generally to bracket for mounting a card reader to a computer monitor.

In one embodiment, a bracket is provided that is engageable with both a computer monitor and a card reader. The bracket affixes the card reader to the monitor presenting a secure position that does not modify the width of the monitor.

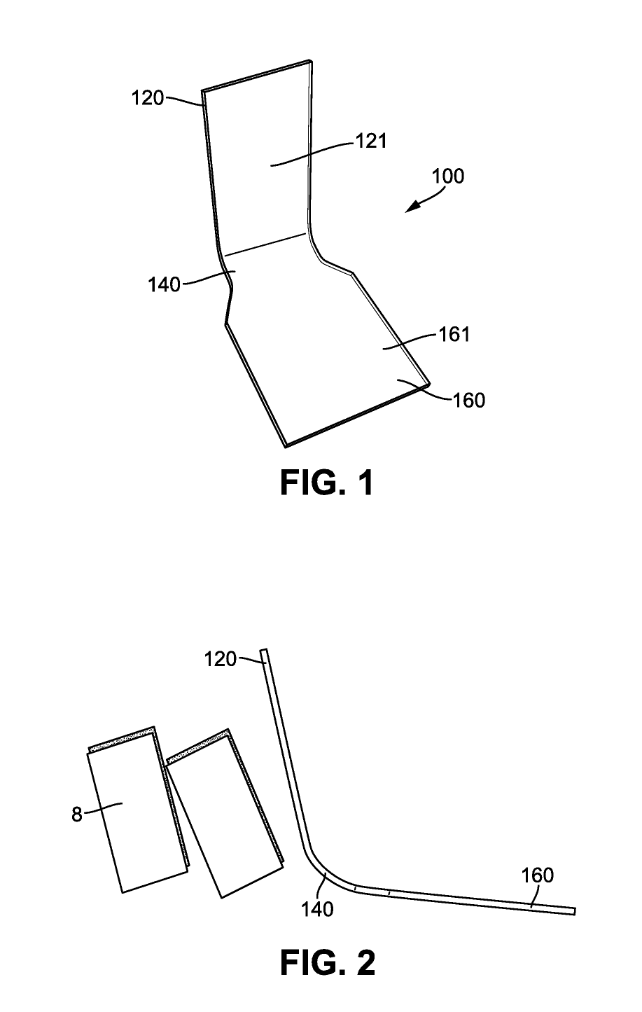

One embodiment of a bracket is illustrated in FIG. 1. The bracket 100 includes an upright portion 120, a transition portion 140, and a support portion 160.

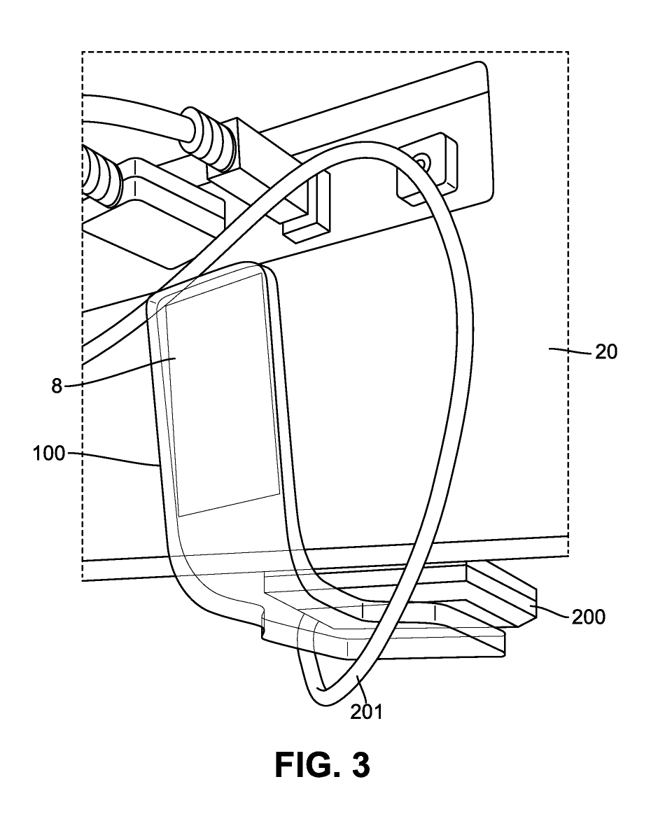

In the illustrated embodiment of FIG. 1, the upright portion 120 has at least one flat surface 121. As seen in the embodiment of FIG. 1, the flat surface 121 faces in the direction that the support portion 160 extends. Thus, when the bracket 100 is positioned so that the upright portion is behind the back of a computer monitor 20 and the support portion 160 extends outward from the front of the monitor, the flat surface 121 may engage with the back of a computer monitor 20 (best illustrated in FIG. 3). Alternatively, the upright portion 120 may have a contoured surface to match the back of the monitor 20. In one embodiment, shown in FIG. 3, the flat surface 121 is engageable with the computer monitor through a connector 8 such as an adhesive (including removable adhesive strips), hook-and-loop fastener, screw, bolt, pin or the like. In a further alternative embodiment, the upright portion 120 may be engageable with a feature of the monitor 20, for example with one or more openings of a Flat Display Mounting Interface, such as VESA bolt holes.

As best shown in FIG. 2, the transition portion 140 connects the upright portion 120 to a support portion 160. The transition portion 140 may be a bend in the unitary material of the bracket 100. The transition portion 140 may have an associated bend angle between 70 degrees and 120 degrees. In one embodiment, the transition portion 140 includes an adjustable bend angle. The transition portion 140 may be adjustable due to flexibility of the material used for the transition portion 140.

The support portion 160 extends at an angle of between 70 degrees and 120 degrees relative to the upright portion 120. The support portion 160 extends from the transition portion 140. Thus, where the upright portion 120 is engaged with the back of the monitor 20, the transition portion 140 is positioned at the bottom edge of the monitor 20 with the support portion 160 extending outward past the front of the monitor 20 (best illustrated in FIG. 3). As seen in the embodiment of FIG. 1, the support portion 160 has a flat upper surface 161 configured to receive a card reader 200. Alternatively, the support portion 160 may be configured with a surface contoured to engage with the card reader 200.

The upright portion 120 may be narrower than the support portion 160. In one embodiment, the upright portion has a length of 2 inches to 8 inches and a width of 1 inch to 3 inches. In one embodiment, the support portion 160 has a length of 2 inches to 5 inches and a width of 2 inches to 4 inches. In one embodiment, the thickness is selected from 1/16, ⅛, 3/16, ¼, 5/16, ⅜, 7/16, ½ inches. The support portion 160 is, in one embodiment, longer than the thickness of the monitor 20 to enable the support portion 160 to extend beyond the monitor 20 and support a card reader 200.

In one embodiment, the card reader 200 has a wire 201 extended therefrom, such as a USB wire for communication and power. A wire opening (not show) may be provided in the bracket 100. For example the wire opening may be a circular, elliptical or stadium shaped opening in the material of the bracket, at one or more of the support portion 160, the transition portion 140 and the upright portion 120. Further, wire management structures may be attached to or used in combination with the bracket 100.

One method of preparing and using the bracket 100 is 1) prepare for mounting by cleaning the upright 120 and support portion 160 surfaces with an alcohol swab, 2) prepare the surface to which it will be mounted by cleaning the area with an alcohol swab, 3) attach one piece of the double sided tape (or other adhesive film product) to the upright portion flat surface 121, 4) line the bracket 100 to where the bracket 100 will be mounted, 5) mount the bracket 100 to surface by removing the cover on the tape and pressing the bracket 100 firmly to the surface, 6) prepare the card reader 200 by cleaning the underside with an alcohol swab, 7) attach the 2nd piece of double-sided tape/adhesive to the underside of the reader 200 by removing the protective cover on the tape/adhesive and firmly pressing the tape/adhesive unto the underside of the reader 200, 8) remove protective covering on tape/adhesive, 9) align reader 200 so that it is perpendicular to the edge of the support portion flat surface 161 and firmly press reader onto support portion 161 of bracket 100.

In one embodiment, the bracket 100 is comprised of a single unitary piece of acrylic. Once acrylic sheets and double-sided tape/adhesive have been procured, the acrylic sheets will be cut to proper dimensions and shaped, once proper size is obtained the acrylic pieces will be heated to 275-350 degrees Fahrenheit and formed so that a 20-30 degree angle is obtained between the vertical and horizontal surfaces.

Angles can be altered to allow increased flexibility where customization maybe required.

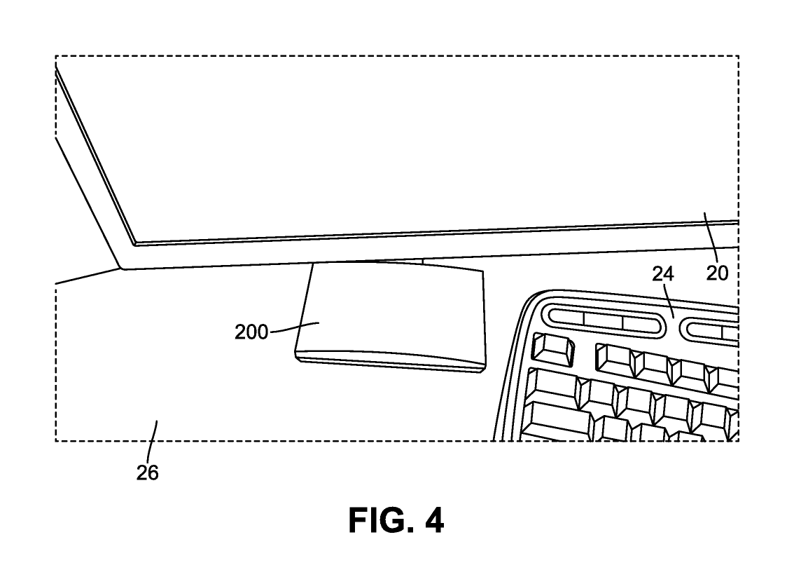

By using this product the consumer will be able to solve the challenges associated with mounting ID card readers so that they are accessible to end user and staff. The bracket allows the consumer to place the reader in a highly visible location accessible to end users and staff. For example, as seen in FIG. 4, the reader 200 may be suspended by the bracket 100 over a desk 26, including placing the reader 200 above the level of a keyboard 24, thus placing it in a easily visible and accessible location for the user.

As used herein, the singular forms “a”, “an” and “the” include plural referents unless the context clearly dictates otherwise. Thus, for example, the term “a member” is intended to mean a single member or a combination of members, “a material” is intended to mean one or more materials, or a combination thereof.

As used herein, the terms “about” and “approximately” generally mean plus or minus 10% of the stated value. For example, about 0.5 would include 0.45 and 0.55, about 10 would include 9 to 11, about 1000 would include 900 to 1100.

It should be noted that the term “exemplary” as used herein to describe various embodiments is intended to indicate that such embodiments are possible examples, representations, and/or illustrations of possible embodiments (and such term is not intended to connote that such embodiments are necessarily extraordinary or superlative examples).

The terms “coupled,” “connected,” and the like as used herein mean the joining of two members directly or indirectly to one another. Such joining may be stationary (e.g., permanent) or moveable (e.g., removable or releasable). Such joining may be achieved with the two members or the two members and any additional intermediate members being integrally formed as a single unitary body with one another or with the two members or the two members and any additional intermediate members being attached to one another.

It is important to note that the construction and arrangement of the various exemplary embodiments are illustrative only. Although only a few embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter described herein. Other substitutions, modifications, changes and omissions may also be made in the design, operating conditions and arrangement of the various exemplary embodiments without departing from the scope of the present invention.

While this specification contains many specific implementation details, these should not be construed as limitations on the scope of any inventions or of what may be claimed, but rather as descriptions of features specific to particular implementations of particular inventions. Certain features described in this specification in the context of separate implementations can also be implemented in combination in a single implementation. Conversely, various features described in the context of a single implementation can also be implemented in multiple implementations separately or in any suitable subcombination. Moreover, although features may be described above as acting in certain combinations and even initially claimed as such, one or more features from a claimed combination can in some cases be excised from the combination, and the claimed combination may be directed to a subcombination or variation of a subcombination.

What is claimed is:

1. A bracket comprising:
an upright portion having at least one flat surface configured to be affixed to a computer monitor;
a transition portion connecting the upright portion to a support portion; and
a support portion extending at an angle of between 70 degrees and 120 degrees relative to the upright portion, the support portion having a flat upper surface configured to receive a card reader;
wherein the upright portion has as width less than a width of the support portion.

2. The bracket of claim 1, further comprising a wire opening in the bracket.

3. The bracket of claim 1, further comprising an adhesive surface affixed to the at least one flat surface of the upright portion.

4. The bracket of claim 1, further comprising a second adhesive surface affixed to the flat upper surface of the support portion.

5. The bracket of claim 1, wherein the upright portion has a length of between 2 inches and 8 inches and wherein the support portion has a length of between 2 inches and 5 inches.

6. A system for managing access via a card reader, the system comprising:
a bracket comprising:
an upright portion having at least one flat surface configured to be affixed to a computer monitor;
a transition portion connecting the upright portion to a support portion; and
a support portion extending at an angle of between 70 degrees and 120 degrees relative to the upright portion, the support portion having a flat upper surface configured to receive a card reader;
and
a card reader positioned on the support portion.

7. The system of claim 6, further comprising a wire opening in the bracket.

8. The system of claim 6, further comprising an adhesive surface affixed to the at least one flat surface of the upright portion.

9. The system of claim 6, further comprising a second adhesive surface affixed to the flat upper surface of the support portion.

10. The system of claim 6, wherein the upright portion has a length of between 2 inches and 8 inches and wherein the support portion has a length of between 2 inches and 5 inches.

11. A system for managing access via a card reader, the system comprising:
a computer monitor having a back surface, a front display surface, and a thickness defined therebetween;
a bracket comprising:
an upright portion having at least one surface configured to be affixed to a computer monitor;
a transition portion connecting the upright portion to a support portion; and
a support portion extending at an angle of between 70 degrees and 120 degrees relative to the upright portion and further extending at least a distance from the upright portion greater than the thickness of the computer monitor, the support portion having a flat upper surface positioned in front of the front display surface of the monitor and configured to receive a card reader;
and
a card reader positioned on the support portion.

12. The system of claim 11, wherein the at least one surface of the upright portion is flat.

13. The system of claim 12, wherein the at least one upper surface of the support portion is flat.

14. The system of claim 13, wherein the card reader is positioned in front of the computer monitor.

15. The system of claim 13, further comprising a wire opening in the bracket.

16. The system of claim 13, further comprising an adhesive surface affixing the at least one flat surface of the upright portion of the bracket to the computer monitor back surface.

17. The system of claim 14, further comprising a second adhesive surface affixes the card reader to the flat upper surface of the support portion.

18. The system of claim 11, wherein the upright portion has a length of between 2 inches and 8 inches and a width of 1 to 3 inches and wherein the support portion has a length of between 2 inches and 5 inches and a width of 2 to 4 inches and further wherein the upright portion is longer and narrower than the support portion.
